(19) United States
(12) Patent Application Publication
(10) Pub. No.: US 2017/0119623 A1
(43) Pub. Date: May 4, 2017

(54) ELECTROMECHANICAL CHEST COMPRESSION SYSTEM AND METHOD

(71) Applicant: RESUSCITATION INTERNATIONAL, LLC, Scottsdale, AZ (US)

(72) Inventor: Robert G. Attarian, Mesa, AZ (US)

(73) Assignee: RESUSCITATION INTERNATIONAL, LLC, Scottsdale, AZ (US)

(21) Appl. No.: 15/314,184

(22) PCT Filed: May 28, 2015
(86) PCT No.: PCT/US15/32979

§ 371 Date: Nov. 28, 2016

Related U.S. Application Data
(60) Provisional application No. 62/004,561, filed on May 29, 2014.

(51) Int. Cl. A61H 31/00

(52) U.S. Cl. CPC A61H 31/006; A61H 2201/1215; A61H 2201/5007; A61H 2205/084

(57) ABSTRACT

An electromechanical chest compressor is provided with a reciprocating member for contacting a patient's chest; the reciprocating member extends from and retracts into a housing positioned on a patient's chest maintained in contact with a patient by a circumscribing thoracic cavity belt. The reciprocating member is driven by a follower in contact with a rotating drive screw. The drive screw is mounted coaxially with and internally of a permanent magnet DC motor and is connected to the motor's rotor. The current supplied to each of the individual stator windings of the motor is independently controlled by a control system that accesses addresses in a look-up table to determine the value of the current to be supplied to the individual windings.

### RELATED APPLICATIONS

This application is related to and claims priority to a provisional application entitled “ELECTROMECHANICAL CHEST COMPRESSION SYSTEM AND METHOD” filed May 29, 2014, and assigned Ser. No. 62/004,561.

### FIELD OF THE INVENTION

The present invention relates to the administration of cardiopulmonary resuscitation and more particularly to a chest compression system incorporating an electromechanical chest compressor to facilitate increased efficacy of resuscitation techniques.

### BACKGROUND OF THE INVENTION

The performance of manual cardiopulmonary resuscitation (CPR) by first responders of sudden cardiac arrest victims is disappointing despite years of extensive efforts and training by the American Heart Association and other organizations to improve the application of CPR and survival rates for the victims. The standards for manual CPR are the American Heart Association guidelines which call for at least 100 compressions per minute to a sternal depth of two inches into the chest when using manual compression technique. This standard is difficult to meet manually and generally cannot be sustained for more than a few minutes although the first responder may be physically fit.

Powered CPR systems have been developed that replace manual compressions required for proper performance and administration of CPR. See for example U.S. Pat. No. 7,060,041. Portability and simplicity of such systems for CPR are essential attributes of such systems but frequently they are cumbersome as a result of the requirement for the length of the stroke of the piston used in such devices to provide the compressive force on a patient's chest. Such powered devices, whether pneumatic or electrical, typically incorporate a housing having a piston that extends therefrom upon application of power to the unit. The housing is positioned on the patient's chest and is secured to the patient by a torso wrap or belt that surrounds the patient's chest and attaches to the housing. When the unit is powered, a piston extends axially from the housing into contact with the patient's chest and extends the required distance to provide the recommended 2 inch compression to the chest of the patient.

### SUMMARY OF THE INVENTION

An electromechanical chest compressor is provided with a reciprocating member for contacting a patient's chest and that extends from and retracts into a housing positioned on the patient's chest and maintained in contact with a patient by a circumscribing thoracic cavity belt. The reciprocating member is driven by a follower in contact with a rotating drive screw. The drive screw is mounted coaxially with and internally of a permanent magnet DC motor and is connected to the motor's rotor. The motor's stator poles and corresponding stator windings are equally spaced about the stator. The windings are energized by DC current from a power source. The current supplied to each individual winding is independently controlled by a control system; the current supplied to each winding is selected from a lookup table having a plurality of addresses corresponding to each winding. Each address within the plurality of addresses contains a value corresponding to the amplitude of the current to be delivered to the corresponding winding. The timing and positional information of the rotor is detected by an encoder connected to the rotor and is provided through a quadrature decoder and address decoder to develop the appropriate address to be accessed within the lookup table. The address developed by the address decoder is phase shifted by a phase shifter to develop an offset angle that results in the address being modified and thus the current level being accessed to be advanced or delayed from the address originally developed by the address decoder. In a preferred embodiment, the RPM of the rotor is detected by the encoder and provided to a digital signal processor that provides an offset angle to be implemented by the phase shifter to modify the address that is being accessed at that moment in the lookup table. In this manner, an offset angle is imposed on the angle being accessed in the lookup table in accordance with the motor RPM. The desired offset angle corresponding to the motor RPM may be established for the specific type of motor being utilized in the system to establish a given offset angle for each RPM that produces the most efficient operation of the motor at the selected RPM.

An alternative embodiment selects the offset angle in accordance with the total current required by the motor to maintain a given RPM; in this latter alternative, the offset angle is selected to maintain the minimum total current required by the motor to maintain the given RPM under all load conditions. This embodiment becomes an adaptive technique to select the appropriate offset angle for any given RPM.

### BRIEF DESCRIPTION OF THE DRAWINGS

The present invention may more readily be described by reference to the accompanying drawings in which:

FIG. 1 is a perspective view of an electromechanical chest compressor constructed in accordance with the teachings of the present invention attached to a circumscribing thoracic cavity belt positioned on a patient.

FIG. 2 is an enlarged view of the electromechanical chest compressor of FIG. 1 illustrating the attachment of the compressor to the thoracic belt.

FIG. 3 is a cross-sectional view of an electromechanical chest compressor constructed in accordance with the teachings of the present invention and corresponding to the chest compressor shown in FIGS. 1 and 2.

FIG. 4 is a cross-sectional view of the electromechanical chest compressor of FIG. 3 shown in an extended cylinder position.

FIG. 5 is a cross-sectional view of non-rotating components of the electromechanical chest compressor of FIGS. 3 and 4.

FIG. 6 is a cross-sectional view of the rotating components of the electromechanical chest compressor of FIGS. 3 and 4.

FIG. 7 is a simplified functional block diagram of the electromechanical chest compressor system of the present invention.

FIG. 8 is an illustration of a simplified functional block diagram of a typical prior art permanent magnet direct current motor speed control.

FIG. 9 is a schematic representation of the stator and rotor of a typical PMDC motor configuration.

FIG. 10 is a functional block diagram of the PMDC motor control used in the system of the present invention.

FIG. 11 is a schematic representation of a plurality of groups of addresses of the memory lookup table utilized in the system of the present invention.

FIG. 12 is a schematic representation of a single group of addresses corresponding to a specific stator coil.

FIG. 13 is a schematic representation of a PMDC motor phase velocity curve showing the relationship of RPM to the electrical phase angle required to operate at maximum efficiency.

FIG. 14 is a time/position curve representing the extension/retraction of a chest pad during operation of the chest compressor of the present invention.

### DETAILED DESCRIPTION OF THE INVENTION

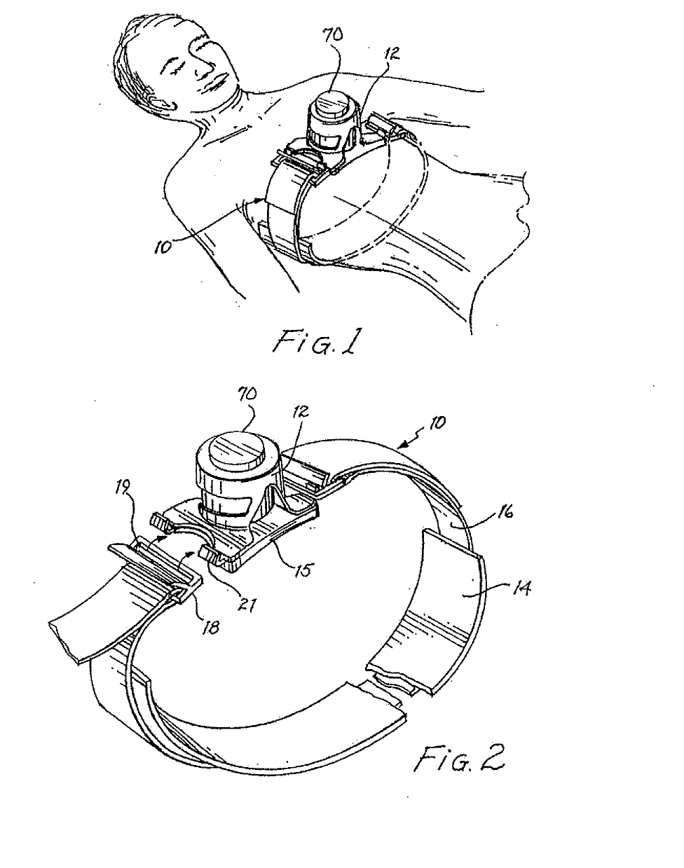

Referring to FIG. 1, an electromechanical chest compressor system constructed in accordance with the teachings of the present invention is shown schematically positioned on the chest of a patient. The compressor 12 is maintained in its strategic position on the patient's chest through the utilization of a thoracic cavity belt 10. The thoracic cavity belt 10 circumscribes the patient's thoracic cavity and may more readily be seen by reference to FIG. 2 wherein it may be seen that a primary strap 14 is provided that partially circumscribes the patient's thoracic cavity when the strap is in place on the patient. The primary strap 14 is a minimum 5 to 6 inches wide and preferably 7 inches wide or more and may be formed of a laminated neoprene and cotton to provide transverse stiffness to maintain a maximum area of belt-patient contact with the patient during compression and release of pressure cycles administered in the resuscitation process.

A secondary strap 16, narrower than the primary strap and attached thereto extends further around the patient's thoracic cavity. The secondary strap 16 is narrower than the primary strap but nevertheless is at least 4 inches wide to maintain a significant belt-patient contact area with the thoracic cavity of the patient. The secondary strap may be made of cotton; each end of the secondary straps is threaded through a corresponding attachment buckle 18 and is folded back upon itself with the respective ends secured to the secondary strap through a hook and loop contact such as Velcro®. The attachment buckles 18, in addition to receiving the ends of the secondary strap, incorporate hook engaging slots 19 to receive buckle engaging hooks 21 attached to a strap insert 15. The thoracic cavity belt 10 is then tightened by pulling the ends of the secondary strap through the attachment buckles with sufficient force to firmly secure the electromechanical chest compressor in place. In the embodiment shown in FIGS. 1 and 2, the strap insert 15 may be a rigid platform for supporting the electromechanical chest compressor 12.

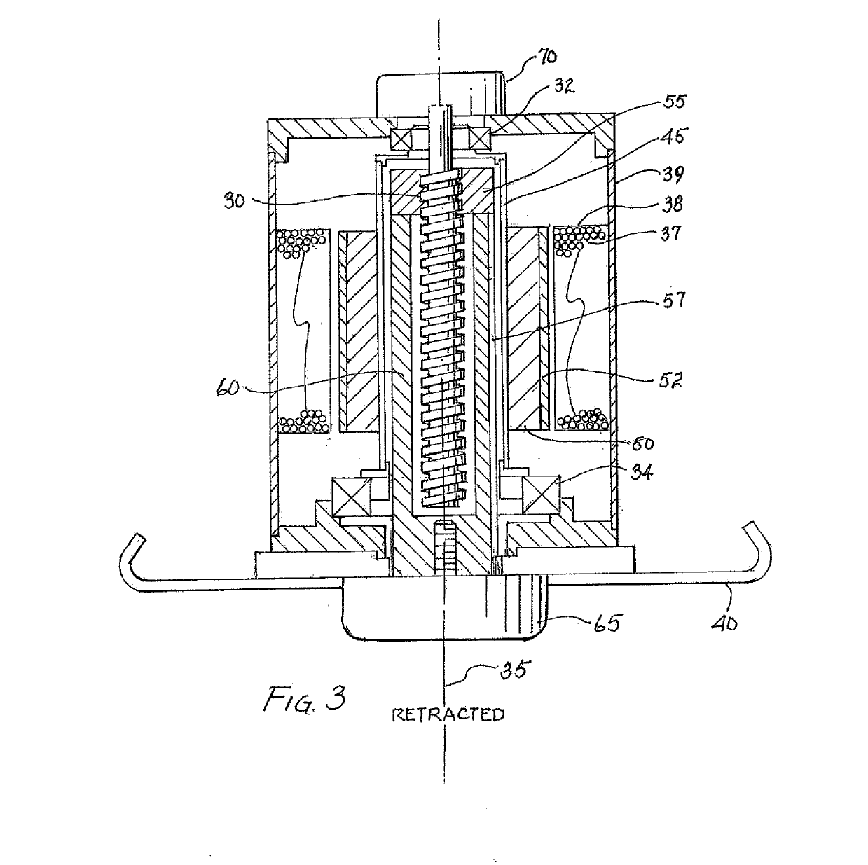

Referring to FIG. 3, a cross-sectional view of an electromechanical chest compressor constructed in accordance with the teachings of the present invention is shown. In the view shown in FIG. 3, the chest compressor is in its retracted position; that is, the compressor is shown with its contact with the patient's chest in a retracted position. The chest compressor is provided with a rotating drive screw 30 that is journaled in bearings 32 and 34, respectively, and mounted for rotation about an axis which, in the embodiment chosen for illustration, corresponds to longitudinal axis 35 that is approximately perpendicular to a patient's chest when positioned on the patient. The compressor is provided with stator windings 37 mounted within a housing 39. The windings of the stator 38 are supplied current having a magnitude and polarity in a manner to be described. It may be noted that the housing 39 and stator 38 remain stationary during the operation of the compressor; further, it also may be noted that the housing 39 is secured to a bracket 40 formed as part of the buckle engaging hooks 21 shown in FIGS. 1 and 2 which are releasably engaged by buckles 18 of the circumscribing belt 10

A rotating hollow cylinder 45 is journaled in the bearings 32 and 34 and supports the rotor 50 and the permanent magnets 52 secured thereto. The number of stator poles and corresponding windings and the number of permanent magnets may be selected in accordance with existing direct current permanent magnet motor designs. That is, in the embodiment chosen for illustration the motor configuration may be referred to as 10-12 configuration; this designation indicates that there are ten permanent magnets secured to the rotor 50 and twelve stator poles and corresponding windings or coils 37 uniformly positioned about the interior of the stator housing 39.

The rotating drive screw 30 is mounted for rotation about the axis 35 as stated previously and therefore rotates clockwise or counterclockwise as viewed from the top of the compressor. A follower member such as drive nut follower 55 engages the rotating drive screw 30 and includes a key engaging a stabilizing keyway 57 to prevent drive nut follower 55 rotation as the follower 55 is engaged by and driven by the rotating drive screw 30. Thus, as the rotating drive screw 30 rotates, the drive nut follower 55 is driven linearly along the axis 35 and produces oscillatory motion as it alternately extends downwardly and upwardly along the axis as it is being driven by the rotating drive screw 30. The drive nut follower 55 is secured to a non-rotating reciprocating member which may take the form of reciprocating cylinder 60 that is driven by the drive nut follower 55 as the reciprocating cylinder 60 alternately extends and retracts from within the housing 39.

A chest pad 65 is secured to the reciprocating cylinder 60 and thus alternately extends from and is retracted toward the housing as the reciprocating cylinder 60 travels upwardly and downwardly in response to being driven by the drive nut follower 55 that, in turn, is being driven by the rotating drive screw 30.

The rotating drive screw 30 is provided with an extension engaging an encoder 70 that provides rotational velocity (RPM) and positional information of the magnets in relation to stator coils in a manner to be described.

In operation, excitation of the stator windings 37 in a manner to be described results in the rotation of the rotating hollow cylinder 45 driving the rotating drive screw 30 thus resulting in the drive nut follower 55 being driven axially of the drive screw. The rotational velocity (RPM) of the drive screw, its acceleration and deceleration, and direction of rotation are thus controlled by the motion of the rotor 50 which in turn is controlled by the excitation of the stator windings 37. The reciprocating motion of the chest pad 65, connected to the reciprocating cylinder 60, is thus controlled to provide a desired extension depth, as well as velocity and force, necessary to achieve the desired timing and distance parameters for appropriate resuscitation resulting from the chest pad's contact with the patient's chest.

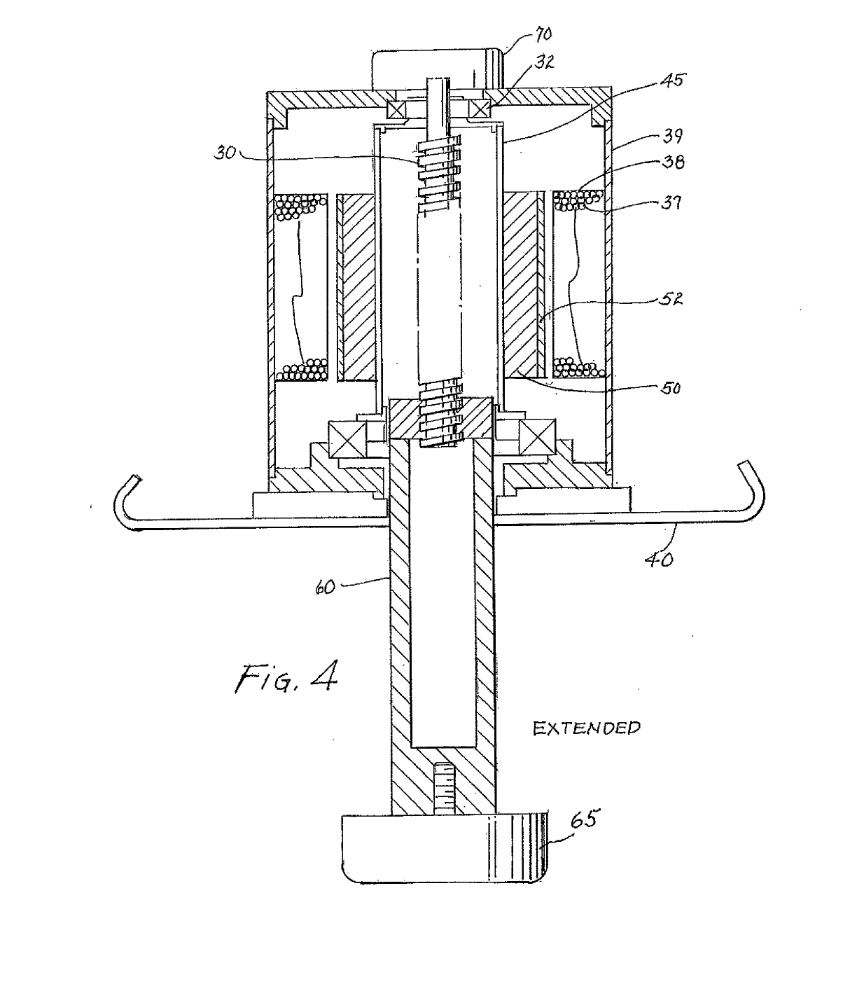

Referring to FIG. 4, the electromechanical chest compressor of FIG. 3 is shown wherein the reciprocating cylinder 60 and attached chest pad 65 are in the extended position. It may be seen that the excitation of the stator windings 37 has rotated the rotor and rotating hollow cylinder 45 causing the rotation of the rotating drive screw 30 to rotate in a clockwise motion as viewed from the top of FIG. 4. This clockwise rotation of the rotating drive screw has resulted in the linear extension of the drive nut follower 55, and attached reciprocating cylinder 60 to the position shown in FIG. 4. It may be seen that when the housing 39 is secured by the brackets 40 to the thoracic cavity belt 10, the extension of the chest pad 65 in contact with the patient's chest will cause chest compression; the length of the compression or, distance of extension of the chest pad from its retracted position, may be controlled as well as the number of extensions per unit of time. The time/distance of the extension as well as the force necessary for such extension are controlled by controlling the current supplied to the stator windings in a manner to be described.

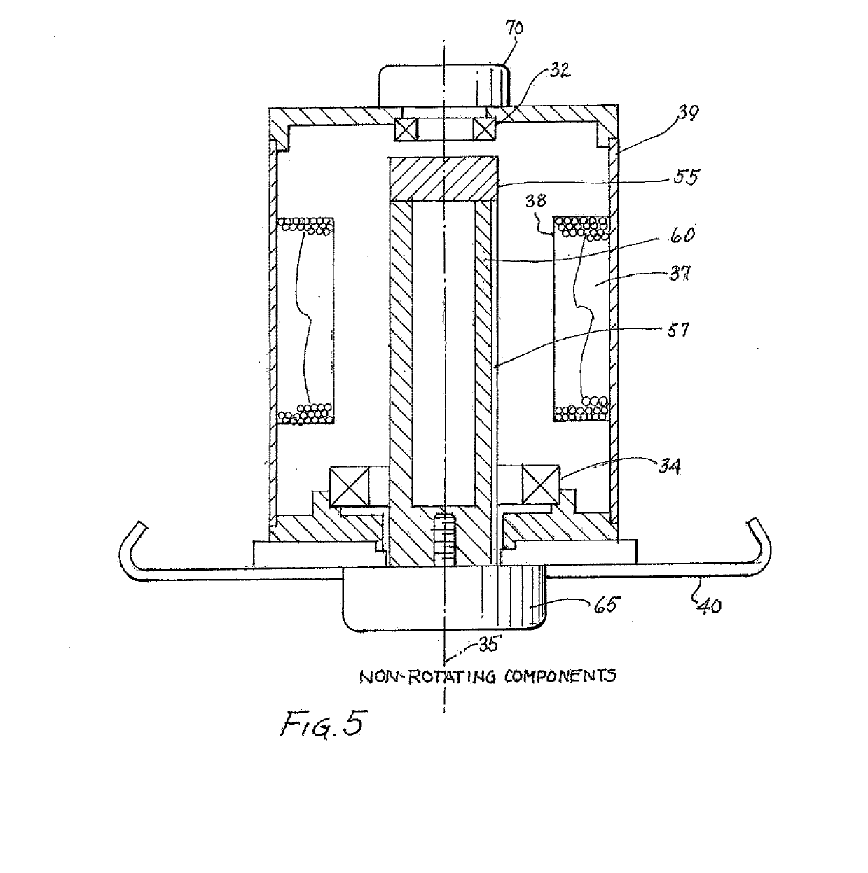

Referring to FIG. 5, the non-rotating components of the electromechanical chest compressor of FIG. 4 are shown. It may be seen that the housing 39 supports the encoder 70, the stator 38 and stator windings 37, the housing supports bearings 32 and 34 and the reciprocating hollow cylinder 60, driven by the drive nut follower 55 which supports the chest pad 65. The housing 39 is secured to the bracket 40 for connection to a thoracic cavity belt 10 as previously described. The chest pad 65, reciprocating hollow cylinder 60 and drive nut follower 55 reciprocate along axis 35 resulting in the chest pad contacting and compressing the patient's chest during operation of the chest compressor.

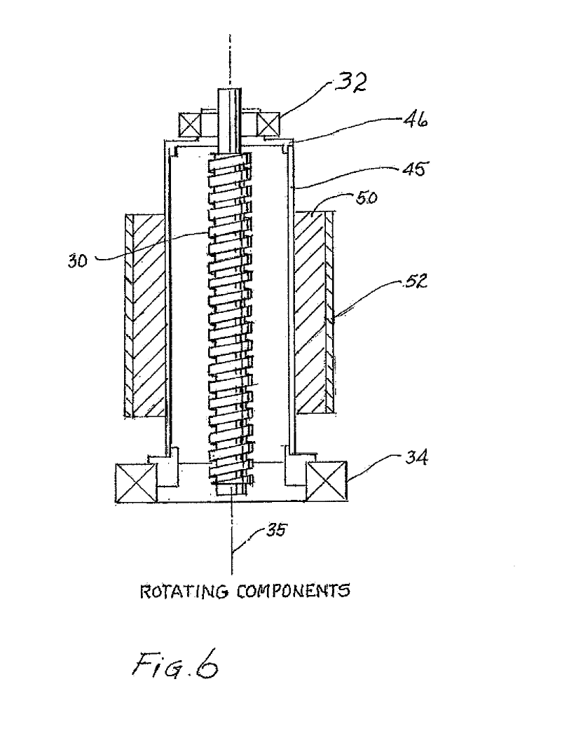

Referring to FIG. 6, the rotating components of the electromechanical chest compressor of FIG. 3 are shown. The bearings 32 and 34 in typical fashion include bearing races that rotate with the components secured thereto including the rotating hollow cylinder 45 and an end cap 46 that facilitates mounting the rotating hollow cylinder 45. The rotor 50 and permanent magnets 52 are attached to and rotate with the rotating hollow cylinder 45 while the rotating drive screw 30 is secured to the rotating hollow cylinder 45 by an end cap 46. Thus, during operation, the rotor 50, rotating hollow cylinder 45 with its end cap 46 drive the rotating drive screw 30 clockwise or counterclockwise at a speed and duration controlled by the excitation of the chest compressor's stator coils.

The preferred embodiment described above provides a rotating drive screw 30 mounted within the housing and positioned for rotation about the axis 35. The drive screw 30 thus rotates about the axis but is not permitted to reciprocate; that is, it rotates about the axis 35 but is restrained from movement along the axis. The non-rotating drive nut follower 55 engages the rotating drive screw 30 and is thus driven by the rotation of the drive screw along the axis 35. As the rotation of the rotating drive screw 30 reverses, the axial motion along the axis 35 of the drive nut follower 55 also reverses. Thus, the drive nut follower 55 reciprocates along the axis 35; the reciprocating cylinder 60, attached to the drive nut follower 55 therefore reciprocates along the axis 35 and extends from and retracts into the housing 39. It will be obvious to those skilled in the art that the respective motions of the follower 55 and the screw drive may be reversed. That is, the parts of the mechanism can be reversed to the extent that the drive nut follower 55 is mounted to rotate with the rotor 50 and the drive screw is keyed to prevent rotation. This reversal of the relative motion would thus cause the drive screw 30 to reciprocate along the axis 35. While the follower 55 would have to be repositioned, the reciprocating motion would provide the reciprocating action of the chest pad 65 in contact with the patient's chest.

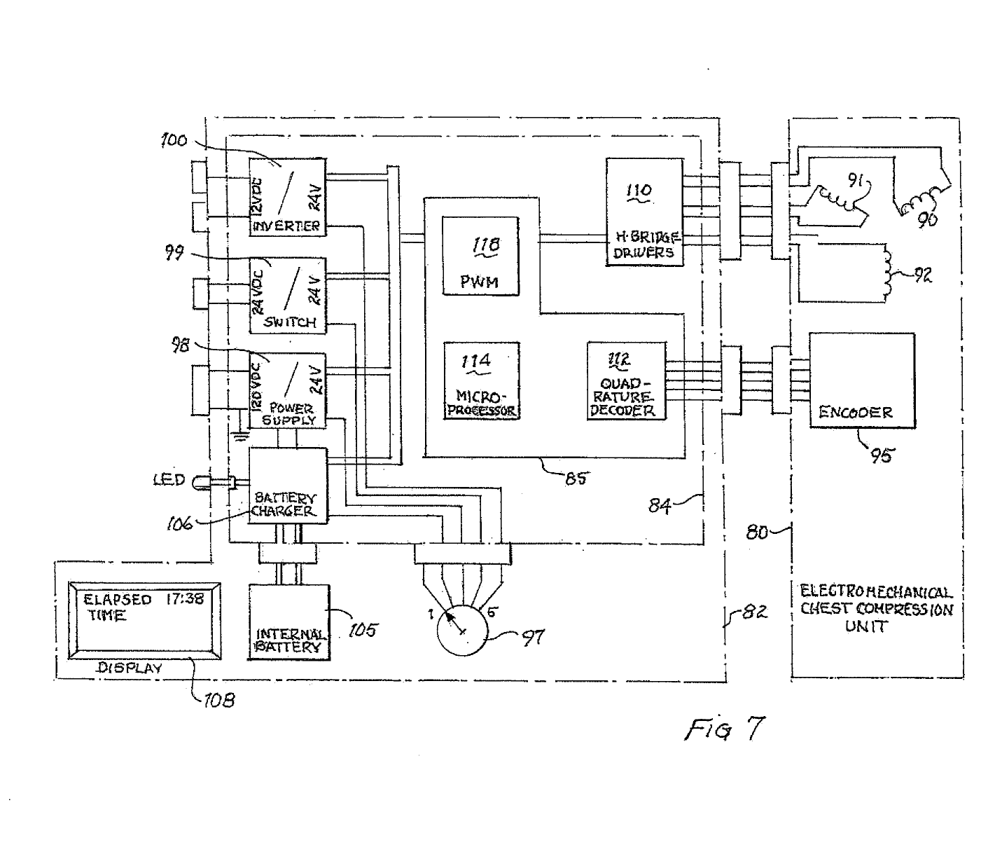

Referring to FIG. 7, a functional block diagram of the electromechanical chest compressor system of the present invention is shown. The figure schematically shows the chest compressor unit 80, a power supply selection unit 82, a power supply 84, and a control unit 85. The chest compressor unit chosen for illustration indicates only three stator windings 90, 91 and 92, it will be understood that the number of stator windings and permanent magnets may be chosen in accordance with permanent magnet direct current (PMDC) motor designs chosen for a specific application. As indicated previously the present design is chosen as a 10-12 configuration indicating ten permanent magnets secured to the rotor and twelve stator poles and corresponding windings uniformly positioned about the interior of the stator housing. It may be noted that each of the individual stator windings 90, 91 and 92 is independently controlled; that is, each winding is supplied with a current that is controlled by a controller. The chest compressor includes an encoder 95 that provides information concerning the rotor and its position with respect to the stator windings.

The power supply unit 84 permits the operator to select a source of power for utilization in the system. The selection may be provided by a selector switch 97 that chooses a power source among a conventional power supply 98 (a rectified 120 volt alternating current source), a convenient 24 volt direct current source 99 or a 12 volt direct current source 100 that provides an inverter for modifying the voltage to a chosen 24 volt direct current. It may be noted that the 12 volt direct current may conveniently be an automotive or portable battery system such as found on a first responder's vehicle, while the 120 volt alternating current system may be a conventional industrial/household/commercial electrical outlet. Alternatively, an internal battery 105 with a corresponding battery charger 106 provides the preferred 24 volt DC current power for the system. An optional display 108 may be provided to present desired information such as elapsed time and the like.

The chosen power source is connected to H bridge drivers 110 for directing current to the respective windings of the electromechanical chest compressor unit. Again, it may be noted that each of the stator windings of the compressor unit are independently controlled and supplied appropriate DC current. The current supplied to the respective windings through the corresponding H bridge drivers is controlled in a manner to be described. The control unit 85 is shown connected to the encoder 95 to receive positional information from the chest compressor. This information is provided to a quadrature decoder 112 which provides information to a microprocessor 114 for developing control signals to control the current being supplied to the stator windings.

The control unit 85 thus incorporates the quadrature decoder 112, microprocessor 114 and pulse width modulator 118. The quadrature decoder 112 receives information from the encoder 95 of the chest compressor 80. The information from the quadrature decoder is supplied to the microprocessor 114 that receives the positional information from the quadrature decoder and generates appropriate control signals through a pulse width modulator 118 to selectively modify the current being provided to each of the stator windings. The modification of the current supplied to the respective stator windings is chosen to develop the maximum torque in the DC motor at any selected or given RPM. Maximizing the torque by selectively controlling the current supplied to the individual windings permits the size and bulk of the chest compressor unit to be minimized and to provide electrical efficiencies to thus minimize the required power to produce the resuscitation function. As stated previously, the size and efficiency of the resuscitation unit is critical to the implementation of portability and effectiveness of the resuscitation system.

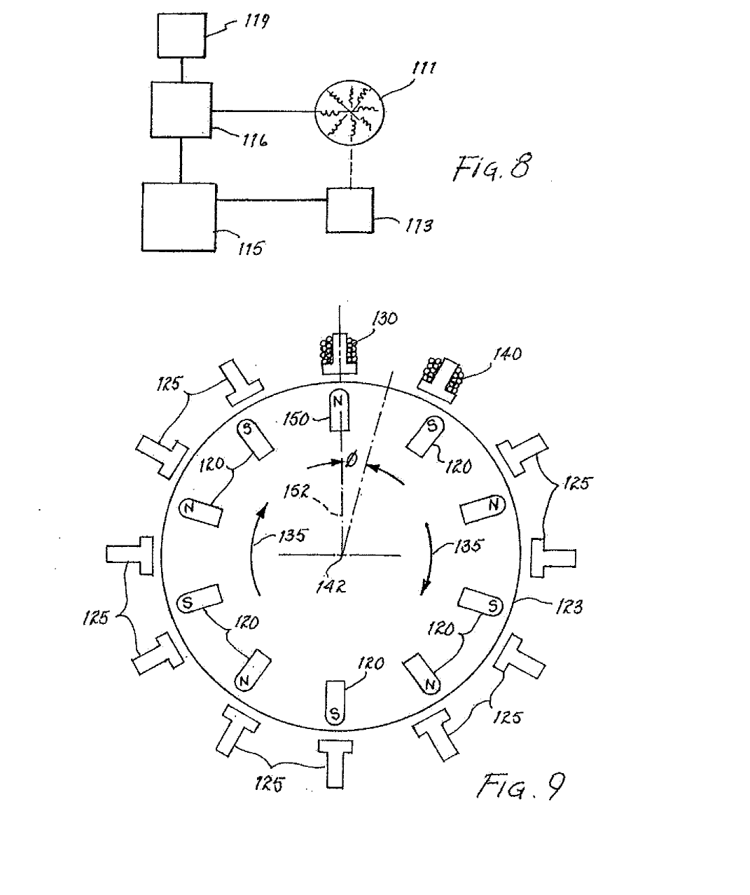

Referring to FIG. 8, a simplified functional block diagram of a typical prior art permanent magnet direct current motor speed control is shown. The controller system is intended to control the speed of the motor 111; a RPM or speed sensor 113 associated with the motor creates a feedback signal indicative of the motor's speed and provides a signal to a controller or a digital signal processor (DSP) 115. The DSP is connected to a current modulator 116 that adjusts the current provided by a power supply 119 and applies the adjusted current to the motor. In this manner, a desired RPM, such as the rated RPM, is achieved by the operating motor. Increases in load applied to the motor tend to slow the motor RPM; however, the speed sensor 113 detects this slowing tendency to provide an indication thereof to the DSP 115 which ultimately modifies the current being supplied to the motor by adjusting the current modulator 116. Thus, the chosen or rated RPM of the motor is maintained by increasing or decreasing the total current supplied to the motor as the load on the motor changes. One embodiment of the present invention includes this speed controlled feedback technique wherein variations in the load which would otherwise result in RPM changes are detected and compensated by the feedback loop which increases or decreases the total current being supplied to the motor. In another embodiment of the present invention and RPM lookup table is provided that has been preprogrammed with appropriate offset angles (to be described) to modify the address being accessed in the memory lookup table to select the most efficient offset angle for the detected RPM.

Referring to FIG. 9, a schematic representation of the stator and rotor of a typical PMDC motor configuration is shown. There are numerous motor configurations available; the schematic representation of FIG. 9 may be referred to as a 10-12 configuration. That is, ten permanent magnets 120 are secured to the rotor 123 and twelve stator coils 125 are uniformly positioned about the stator. If this configuration (10-12) is chosen for the electromechanical chest compressor of the present invention, then FIG. 9 is a schematic representation of a cross-section of FIGS. 3, 4 and 5. Each stator includes a core supporting coil windings such as shown at 130 and 140, respectively. The coil windings have been omitted in the remainder of the cores for simplification; it will be understood that each of the cores is provided with a coil winding, and that excitation of the core windings by supplying current thereto creates an electromagnetic field, the flux of which extends across the gap between the stator and rotor and envelops the permanent magnets of the rotor that are in the vicinity of the electromagnetic field.

The coil windings of the respective cores are not interconnected as in the prior art in well known configurations such as a Y or delta arrangement; rather, each coil is independently connected to a current supply in a manner to be described. In the schematic representation of FIG. 9, the polarity of the respective permanent magnets is indicated and the direction of rotation of the rotor is shown by arrows 135. The strength of the electromagnetic field emanating from each coil will depend on the current being supplied to the coil at that moment; that is, the current may be increased, decreased, or may be reversed (by reversing current flow in the coil) to present a chosen electromagnetic field at any given moment.

When coils 130 and 140 are supplied current, the resulting electromagnetic fields of the two coils overlap or are superposed. Therefore, at any given point between the two coils there will be an attraction or repulsion of the permanent magnet attached to the rotor positioned in the superposed fields. The combined attraction of one coil and the repulsion of the adjacent coil creates a force acting upon the intervening permanent magnet traveling between the coils. This force acting upon the magnet, and therefore acting upon the rotor, causes motion of the magnet and rotor and creates torque and cause rotation about the rotor axis 142.

For purposes of illustration in describing the present system, the permanent magnet 150 is shown aligned directly beneath the coil 130 along a radial 152. Assuming that the rotor is rotating in the direction of the arrows 135, and recognizing that the electromagnetic fields of coils 130 and 140 are superposed, there is a position between the coils wherein the superposed electromagnetic fields of the coils exert the greatest force upon the magnet and thus upon the rotor. That is, as the rotor rotates, and the coils of the respective stator coils are supplied current to create electromagnetic fields; at any given RPM there is an angle φ measured from radial 152 at which maximum force is applied to the magnet. The creation of the superposed magnetic fields between coils may be manipulated so that at any given instance the force being exerted upon the rotor magnet is the maximum force possible. As the rotor rotates, the superposed electromagnetic fields also “rotate” to continuously present electromagnetic fields creating the greatest force on the corresponding magnet. It has been found that the angular position of the superposed fields that create the maximum force on the rotating magnet may be represented as an angle φ. That is, the excitation of the respective electromagnetic stator coils is modified by adjusting the current supplied to the respective coils to create this moving angle φ that continuously leads the rotor magnet. This angle φ is adjusted to maintain the maximum force on the rotating magnets as the rotor rotates. This maximum force, or maximum torque, resulting from the application of electromagnetic field energization is controlled by the system of the present invention by the appropriate modification of current being supplied to the individual coils synchronized with the positional information obtained by an encoder sensing the angular position of the rotor with respect to the stator. In one embodiment of the present invention, the instantaneous current being supplied to the individual coils is modified by sensing the total current being supplied to the motor; the system varies the angle φ until a minimum total current is being supplied to the motor. Under this latter condition, the motor is operating at its chosen or rated RPM and is operating at its minimum total current to maintain that RPM. Increases in load to the motor may result in an attempt to reduce the RPM of the motor which is counteracted and controlled by the speed control technique described above and prevalent in prior art speed controller designs. Thus, an increase in the load may result in the requirement for additional current being supplied to the motor to maintain the desired or rated RPM, but the adaptive system embodiment of the present invention will continue to adjust the current supplied to the individual coils to maintain the angle φ and thus permit the motor to continue to operate under its new load conditions with a minimum current required to maintain that RPM. The result of the implementation of the adaptive embodiment incorporated in the present invention is that the motor operates under any load and at any given RPM and at its greatest efficiency.

In another embodiment wherein the offset angles for various RPMs are predetermined and stored, upon detection of an RPM change, the appropriate offset angle for the newly selected RPM is accessed in an RPM table and implemented to provide an address modification to the lookup table to thus produce a current value for the attached stator winding that produces the greatest torque/efficiency for the motor at the new RPM.

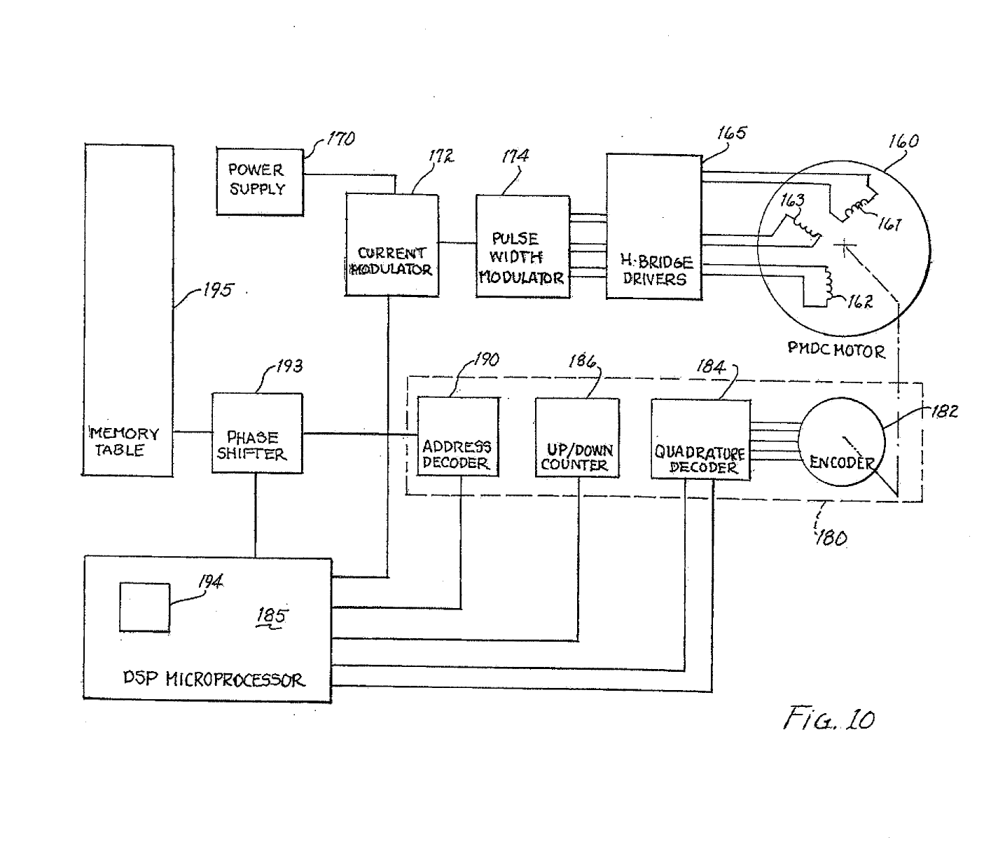

Referring to FIG. 10, a functional block diagram of the PMDC motor control used in the system of the present invention is shown. The permanent magnet direct current motor 160 is shown incorporating a plurality of windings 161-163. The windings are not connected in the conventional Y or delta configuration but are rather each individually driven by current supplied by an H-bridge driver 165 which supplies current to the individual coils and reverses the current to the respective coils when required. H-bridge drivers are well known in the art and need not be described here. Current supplied to the H-bridge drivers 165 for delivery to the respective coils is derived from a power supply 170 whose current is modulated in a current modulator 172 and delivered via a pulse width modulator 174 to the H-bridge drivers. The power supply 170 may be any convenient source of DC current such as storage batteries or rectified AC power. Current modulation and pulse width modulation are well known in the art and will be recognized by those skilled in the art as conventional techniques for manipulating current and supplying current to a utilization device. A feedback loop 180 is provided and connected to the PMDC rotor to provide RPM and positional information of the rotor for utilization in the system. The speed or RPM information derived from the feedback loop 180 is received by a microprocessor 185 that modulates the total current being supplied from the power supply 170 to the motor to maintain a given or rated RPM in a manner described above in connection with the prior art. Alternatively, in another preferred embodiment, the speed or RPM information derived from the feedback loop 180 is received by a microprocessor 185 that can modulate the current being supplied from the power supply 170 by selectively imposing an offset angle that had previously been selected and stored in an RPM lookup table as the optimum offset angle for that detected RPM.

Referring again to FIG. 10, the feedback loop 180 includes an encoder 182 that is secured to the armature shaft of the motor rotor and provides signals concerning rotor rotation to a quadrature decoder 184. The quadrature decoder 184 receives signals from the encoder 182 and determines the rotational direction of the rotor—clockwise or counterclockwise. The information from the quadrature decoder 184 and the encoder 182 are provided to an up/down counter 186 that produces a count modulus corresponding to the number of electrical cycles of the motor. As indicated above, the PMDC motor may be typically wound in several configurations such as 2-3 or 8-12 or as described above 10-12. These numbers represent the number of magnets present on the rotor and the number of stator windings. Depending on the diameter of the motor and its specific torque requirements, the circuit configurations may be repeated many times about the motor. That is, each individual stator coil is provided with electrical current to generate its corresponding electromagnetic field; the energization of the coils is precisely controlled in relation to the positional information defining the position of the individual magnets. The information available from the up/down counter 186 thus provides a precise identification of the position of the rotor, and the position of the rotor magnets relative to the stator windings, at any given moment. An address decoder 190 receives the informational signals from the up/down counter 186 to produce an address corresponding to a specific stator coil.

A memory lookup table 195 is provided containing a plurality of groups of addresses, each group of addresses corresponding to a specific stator coil. Each address within the group of addresses corresponds to a current value to be supplied to the corresponding winding when that address is accessed. The values of the current values stored at each successive address within a group of addresses may be distributed in any particular waveform representation. That is, a typical example would be the successive current values stored in a given group of addresses forming a waveform such as a sine wave. Accessing successive addresses within the group of addresses would thus result in current values to be delivered to the corresponding winding forming a sine wave. Thus, such default values stored at each group of addresses may represent a sine wave or other waveforms. Thus, as the addresses within a group of addresses corresponding to a single coil are sequentially addressed, and the address is adjusted by the phase shifter 193 under control of the microprocessor 185 to adjust the address by an amount equal to offset angle φ and the instantaneous values of the current to be delivered to that coil are made available to the current modulator 172. Thus, as the rotor rotates, the current being delivered to each coil is determined in accordance with the values stored at the adjusted or modified addresses for that coil in the lookup table. The stored value of the current to be supplied to the individual windings is thus provided to the current modulator 172 that delivers current from the power supply 170 at the moment that the corresponding address is accessed.

The offset angle φ such as shown in FIG. 9 may represent a mechanical angle conveniently represented in the rotational environment of a motor; however, the angle φ may be represented as an electrical angle. For example, if the default values of the current amplitude being stored at the respective addresses in the memory lookup table are such that when the respective addresses are addressed in sequence the resulting represented current values present a sine wave, then the angle φ represents a phase shift angle that may be utilized to modify the address of an inquiry to the lookup table. That is, if the positional information indicates that a particular address should be accessed in the lookup table 195, the address decoder 190 provides the address that is modified by the offset phase shift angle φ resulting in the access of the next higher or lower address in the lookup table. The result of the implementation of the offset phase shift angle is the modification of the current value accessed at that time and applied through the current modulator 172 to the specific stator coil. In this manner, the current being supplied to each individual stator coil is modified to implement the modification in the corresponding electromagnetic fields and generate the maximum force, or torque, on the rotor under the influence of the superposed electromagnetic fields.

The total current being supplied to the motor 160 by the power supply 170 is thus modified and distributed to the individual coils in accordance with the current values stored in the lookup table 195 corresponding to the respective individual coils 161, 162 and 163. The total current is controlled, as in the prior art, to maintain a chosen or rated RPM; this total current is ratioed, as apportioned and distributed to the respective individual coils; however, the system of the present invention provides a phase shifter 193 that also receives information from the address decoder 190 and modifies the address being accessed to adjust the address by the offset angle φ. The value of the current stored at that adjusted address is then supplied through the current modulator 172 to thus adjust the current being supplied to that specific coil at the moment of access of the corresponding address.

As the rotor rotates, and successive addresses are accessed for each coil, the value stored in the lookup table provides information for the supply of the appropriate current level to each coil. In the adaptive embodiment of the control system, as the rotor rotates, successive addresses are modified by the offset angle φ to maintain minimum total current while maintaining a given RPM at a given load.

Under microprocessor control, the current values for the respective coils are thus modified to reduce the total current being supplied by the power supply; the microprocessor through the phase shifter continues to adjust the addresses and thus current values stored in the memory lookup table while monitoring motor RPM. The current values being supplied to the individual windings are reduced while maintaining the RPM at its chosen or rated value until the minimum current values in the memory lookup table are reached for that RPM.

As the load on the motor is increased, the RPM tends to lower and is detected by the speed control feedback loop resulting in an increase of the total current supplied to the motor under microprocessor control. At any new load situation, the adaptive embodiment of the motor control used in the system of the present invention continues to modify lookup table address until the RPM begins to lower from the chosen or rated level. The current values in the memory lookup table may then be restored to the next higher level so that the feedback loop for controlling the RPM can continue to maintain motor RPM under the given load conditions. In this manner, the minimum current necessary to maintain motor RPM under any given load conditions is maintained.

Referring to FIG. 11, a schematic representation of a plurality of groups of addresses of the memory lookup table 195 (FIG. 10) is shown. For purposes of illustration, three groups of addresses have been selected for description; each of the groups of addresses A, B and C correspond to a respective stator coil. Each address 196 within each group of addresses represents the value of current to be supplied to the corresponding coil when that address is accessed. For example, at time T addresses 197, 198 and 199 are simultaneously accessed. Each address represents the value of the current to be supplied to the corresponding coil at time T. Thus, the electromagnetic field associated with each coil has a field strength corresponding to the current delivered to the coil; the permanent magnets that are in those respective fields are attracted/repulsed with a force to create torque. The values at each address within a group of addresses is accessed sequentially by the microprocessor control; the addresses being accessed are adjusted by the phase shifter resulting in a modified current being supplied to the respective coil.

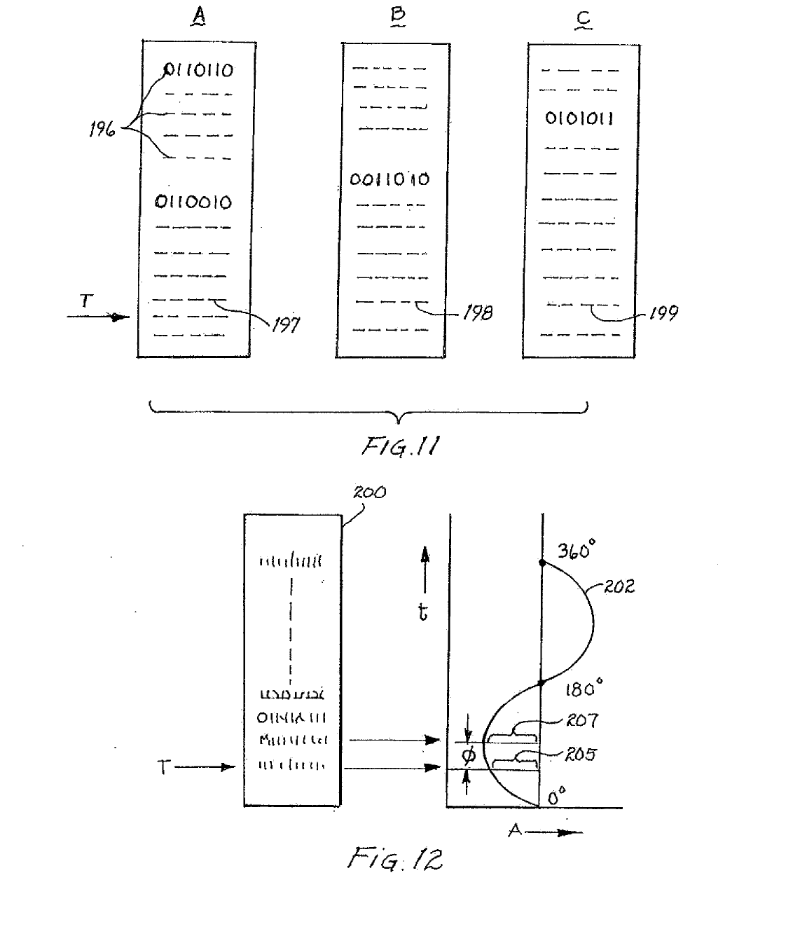

Referring to FIG. 12, a schematic representation of a single group of addresses 200 corresponding to a specific stator coil is shown. The distribution of current values stored in the memory lookup table, when sequentially accessed, conform to a predetermined wave shape such as a sine wave. This default wave shape may take forms other than a sine wave; however, for purposes of illustration, it is assumed that the default current values stored in the memory lookup table 195, when sequentially accessed, conform to a typical sine wave. Assuming that the default current values stored in the lookup table group conforms to a typical sine wave 202 the value of the current delivered to the corresponding coil at time T would normally have an amplitude 205; however, the system of the present invention employs the phase shifter 193 as described above that advances/retards the address wherein the current value being accessed at time T is indicated at 207. The difference in the current value is caused by the offset angle φ results in the modification of the current being supplied to that winding, coordinated with modifications to the current being supplied to adjacent windings, to produce superposed electromagnetic fields of adjacent coils that creates the maximum torque at the chosen or rated RPM.

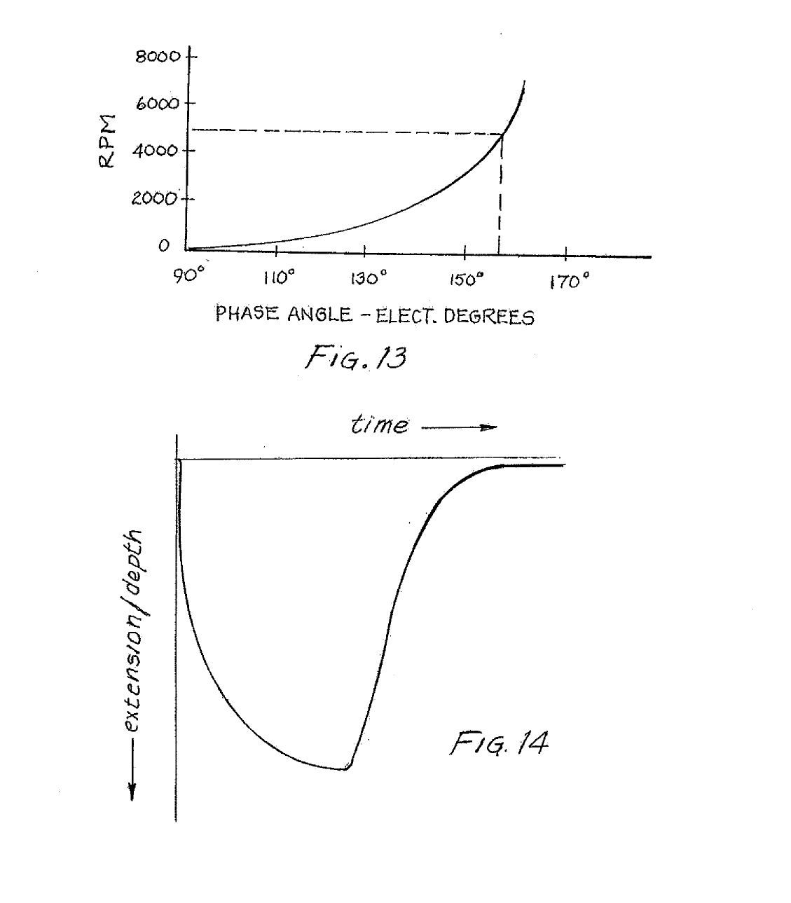

In another embodiment of the invention, a motor control is operated without the adaptive feature that automatically selects the most efficient lookup table address. In this alternative embodiment, the most efficient stator coil currents are predetermined for the specific motor design operating at various rotational velocities. The most efficient phase angles for any RPM are stored in a RPM lookup table 194 that provides the proper phase angle for any selected RPM for each stator coil winding. FIG. 13 is a schematic representation of the typical PMDC motor phase velocity curve showing the relationship of RPM to the electrical phase angle required to operate at maximum efficiency in a non-adaptive control embodiment of the present invention. The permanent phase angles necessary for maximum efficiency at a given RPM are stored in RPM lookup table 194 accessible by the microprocessor. Upon determination of the motor RPM, the microprocessor obtains the stored phase angle corresponding to that RPM.

Referring to FIG. 13, a curve derived from a plot of RPM/electrical phase angle values is shown for use as stored permanent phase angles to be used with a PMDC to ensure maximum efficient at a variety of RPMs. The figure is shown incorporating a typical curve representing the respective electrical degrees phase angle associated with corresponding RPMs of a specific PMDC. As an example, a particular RPM (5,000) is chosen showing that at that RPM the electrical phase angle associated with the maximum efficiency of the PMDC is 158°. Thus, the address derived from the address decoder, modified by the phase shifter, presents an address to the lookup table corresponding to 158°. The value of the current stored at that address is thus the proper value to maintain maximum efficiency of the motor/load at that RPM.

As stated previously, the curve of FIG. 13 may be developed empirically and subsequently utilized for identical motors for use in identical or similar applications. Thus, the utilization of adaptive techniques described in connection with the first preferred embodiment, may not be necessary when the specific RPM/electrical phase angle is known for the development of maximum efficiency and the known and stored value of the offset phase angle can be used for a particular motor design used in a known environment and with a known load.

Since the screw drive incorporated in the present invention inherently has a fixed pitch, the positional information of the rotor is also the positional information of the reciprocating member and attached chest pad. Therefore, controlling the angular rotation of the rotor inherently controls the linear extension of the reciprocating member. Controlling the rotational speed and position of the rotor enables the control of the extension, retraction, and linear speed of the chest pad. Referring to FIG. 14, a plot of a typical chest pad extension/retraction is shown. The depth of the stroke or extension of the chest pad as well as the rate of extension of the pad is readily controlled as well as the repetition rate of the extensions of the chest pad. The depth of the extension may be controlled to accommodate the physical parameters of the patient; for example, the extension is shorter for a child than a large adult. The profile of the extension, that is the changing speed of the extension as the chest pad approaches the end of its extension travel, is controlled by the microprocessor under program control. The time/position curve of FIG. 14 illustrates the time and position of the chest pad; the force being required to produce the curve is the minimum required to achieve the indicated depth/time. The present invention applies the minimum required force by automatically adjusting the current to provide the minimum current and thus only sufficient force to follow the time/position curve.

The present invention has been described in terms of selected specific embodiments of the apparatus and method incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

What is claimed:

1. An electromechanical chest compressor comprising:
(a) a permanent magnet DC motor having a housing for placement on a patient's chest and having a longitudinal axis;
(b) a plurality of stator windings mounted in said housing;
(c) a rotor mounted for rotation about said longitudinal axis and positioned within said housing to form a permanent magnet DC motor;
(d) an encoder secured to said rotor for rotation therewith to provide rotor positional information;
(e) a screw drive mounted for rotation about said axis;
(f) a follower member engaging said screw drive for reciprocating motion when said screw drive rotates;
(g) a chest pad secured to said follower for reciprocating therewith and for placement in contact with the patient's chest;
(h) a power supply for providing electric current to said stator windings; and
(i) a control unit connected to said encoder, power supply and said stator windings for independently controlling the current delivered to each winding.

2. An electromechanical chest compressor comprising:
(a) a permanent magnet DC motor having a housing for placement on a patient's chest and having a longitudinal axis;
(b) a plurality of stator windings mounted in said housing;
(c) a rotor mounted for rotation about said longitudinal axis and positioned within said housing to form a permanent magnet DC motor;
(d) an encoder secured to said rotor for rotation therewith to provide rotor positional information;
(e) a screw drive mounted for rotation about said axis;
(f) a follower member engaging said screw drive for reciprocating motion when said screw drive rotates;
(g) a chest pad secured to said follower for reciprocating therewith and for placement in contact with the patient's chest;
(h) a power supply for providing electric current to said stator windings; and
(i) a control unit connected to said encoder, power supply and said stator windings and having a microprocessor and memory lookup table, said memory lookup table having a plurality of groups of addresses, each group of addresses corresponding to a different one of said stator windings, respectively, each address containing a value of the current to be supplied to a stator winding when the address is accessed.

3. The electromechanical chest compressor of claim 2 wherein said screw drive is secured to said rotor for rotation therewith.

4. The electromechanical chest compressor of claim 3 wherein said follower member is non-rotating.

5. The electromechanical chest compressor of claim 4 wherein said chest pad is mounted on a cylindrical member secured to said follower member.

6. An electromechanical chest compressor comprising:
(a) a permanent magnet DC motor having a housing for placement on a patient's chest and having a longitudinal axis;
(b) a plurality of stator windings mounted in said housing;
(c) a rotor mounted for rotation about said axis and positioned within said housing to form a permanent magnet DC motor;
(d) an encoder secured to said rotor for rotation therewith to provide rotor positional information;
(e) a screw drive mounted within said housing for reciprocating motion along said axis;
(f) a rotating follower member within said housing engaging said screw drive;
(g) a chest pad secured to said screw drive for reciprocating therewith and for placement in contact with the patient's chest;
(h) a power supply for providing electric current to said stator windings; and
(i) a control unit connected to said encoder and to said stator windings and having a microprocessor and memory lookup table, said memory lookup table having a plurality of groups of addresses, each group of addresses corresponding to a different one of said stator windings, respectively, each address containing a value of the current to be supplied to a stator winding when the address is accessed.

7. The electromechanical chest compressor of claim 6 wherein said follower is secured to said rotor for rotation therewith.

8. The electromechanical chest compressor of claim 6 wherein said chest pad is mounted on a cylindrical member secured to said follower member.

9. An electromechanical chest compressor comprising:
(a) a permanent magnet DC motor having a housing for placement on a patient's chest and having a longitudinal axis;
(b) a plurality of stator windings mounted in said housing;
(c) a rotor mounted for rotation about said longitudinal axis and positioned within said housing to form a permanent magnet DC motor;
(d) an encoder secured to said rotor for rotation therewith to provide rotor positional information;
(e) a rotatable screw drive mounted within said housing attached to said rotor for rotation therewith about said axis;
(f) a follower member mounted within said housing engaging said rotating screw drive for reciprocating a motion along said axis;
(g) a chest pad secured to said follower member externally of said housing for reciprocating movement and for placement in contact with the patient's chest;
(h) a power supply for providing electric current to said stator windings; and
(i) a control unit connected to said power supply, encoder and said stator windings and having a microprocessor and memory lookup table, said memory lookup table having a plurality of groups of addresses, each group of addresses corresponding to a different one of said stator windings, respectively, each address containing a value of the current to be supplied to a stator winding when the address is accessed.

10. The electromechanical chest compressor of claim 9 wherein said chest pad is mounted on a cylindrical member secured to said follower member.
